(19) United States
(12) Patent Application Publication
(10) Pub. No.: US 2003/0043352 A1
(43) Pub. Date: Mar. 6, 2003

(54) Exposure apparatus and a device manufacturing method which keep temperature of a diaphragm of a projection optical system substantially constant

(76) Inventors: Yuji Sudoh, Tokyo (JP); Akiyoshi Suzuki, Hadano-shi (JP)

Correspondence Address: FITZPATRICK CELLA HARPER & SCINTO, 30 ROCKEFELLER PLAZA, NEW YORK, NY, 10112, US

(21) Appl. No.: 09/532,022

(22) Filed: Mar. 21, 2000

(30) Foreign Application Priority Data
Mar. 25, 1999 (JP) 081400/1999

(51) Int. Cl. G03C 5/00

(52) U.S. Cl. 355/40

(57) ABSTRACT

An exposure apparatus includes a projection optical system which projects a pattern of a first object (e.g., a reticle) to a second object (e.g., a wafer) by using an exposure beam in order to transfer the pattern from the first object onto the second object, a diaphragm which sets a numerical aperture of the projection optical system, and a mechanism which keeps temperature of the diaphragm substantially constant during an exposure operation by the projection optical system.

### BACKGROUND OF THE INVENTION

1. Field of the Invention

The present invention generally relates to an exposure apparatus having a projection optical system, and a device manufacturing method utilizing the projection optical system.

2. Description of the Related Art

Optical lithography has resulted in the miniaturization of devices, which has increasingly extended its range of application by using the capability of a projection optical system to the limits thereof. Projection optical systems used in exposure apparatuses for optical lithography have been developed along the two streams of a shortened wavelength of exposure light and an increase in a numerical aperture (N.A.) of the projection optical system. Rayleigh's formula is often used as a guide of the capability of a projection optical system. That is, when a wavelength of light used in the exposure is represented by λ, a line width of resolution (RP) and a depth of focus (DOF) are represented by the following formulas:

RP=k₁λ/NA (k₁: coefficient) (1)

DOF=k₂λ/NA² (k₂: coefficient) (2)

From Rayleigh's formula, when the numerical aperture is increased to increase the resolving power, the DOF is reduced. Therefore, the numerical aperture of an exposure apparatus is determined to be a maximum value from the specifications of the apparatus. However, when exposure apparatuses are actually used, they are ordinarily used under exposure conditions optimum to a line width, that is, with an optimum numerical aperture under optimum illumination conditions. For this purpose, a numerical aperture variable mechanism is assembled to the projection optical system of the exposure apparatus so as to set a numerical aperture value according to a line width to be processed.

Incidentally, the projection optical system is required to have stabilized performances as one of its requirements. Particularly, the projection optical system is required to have stability with respect to its environment and stability to with respect to thermal aberration, which is caused by heat absorbed by the glass material of the projection optical system during exposure, and the like.

Conventionally, a method of using a glass material excellent in permeability, a method of restricting the amount of heat absorbed by the projection optical system, and the like, are employed to suppress the influence of the thermal aberration. However, it was found by the inventors that when the projection optical system was used with various kinds of numerical aperture, a heat source, where a maximum amount of heat was generated, was the portion of the diaphragm of the numerical aperture variable mechanism provided with the pupil unit of the projection optical system.

The light from the projection optical system does not directly reach the above-noted portion of the diaphragm. When there is no reticle, a value obtained by dividing the diameter of the extent of the incident light beam at the pupil unit of the light beam in the projection optical system by the diameter of the pupil is ordinarily called a σ value, which should be maintained to be a value of less than 1 in a projection exposure apparatus. The diameter of the pupil of the projection optical system at that time means a value determined by the numerical aperture value used in exposure.

However, the situation is entirely changed when a retile (mask) having a pattern is inserted into the path of the exposure light beam. This is because scattered light (diffracted light) from a pattern of the reticle exists in a light beam having passed through the reticle and the scattered light is irradiated to the diaphragm, while direct light from the projection optical system corresponds to the primary light beam passing through the reticle. Further, the diaphragm is usually composed of a metallic material, or the like, and ordinarily absorbs an exposure beam to a large amount. This is problematic, since even the heat absorbed by the glass material of the projection optical system, which has a large permeability and absorbs an exposure beam only to a slight amount, causes a problem. Therefore, the heat resulting from the beam being absorbed by the diaphragm causes a large problem. When the diaphragm is heated by the exposure beam absorbed thereby, the air in the vicinity of the diaphragm is also heated by the heat of the diaphragm. As a result, the glass material is indirectly heated and a Schlieren effect is produced by the convection of the air, whereby the projection optical system is made unstable.

### SUMMARY OF THE INVENTION

An object of the present invention is to provide an exposure apparatus that is excellent in stability by providing a projection optical system, which stably controls thermal aberration by removing the instability thereof caused by an increase in the temperature of a diaphragm of the projection optical system, as described above.

As a result of the diligent study of the inventors, the present invention has been realized based on a finding that when a projection optical system is used with various kinds of numerical apertures, a heat source, where a maximum amount of heat is generated, is the portion of the diaphragm of a numerical aperture variable mechanism provided with the pupil unit of the projection optical system. That is, the present invention improves the prior art by the provision of a mechanism, which keeps the temperature of the diaphragm constant in order to remove the instability of the projection optical system caused by an increase in the temperature of the diaphragm as described above.

According to one aspect of the present invention, an exposure apparatus comprises a projection optical system which projects a pattern of a first object to a second object by using an exposure beam, in order to transfer the pattern from the first object to the second object, a diaphragm which sets a numerical aperture (N.A.) of the projection optical system, and a mechanism which keeps temperature of the diaphragm substantially constant during an exposure operation by the projection optical system.

According to another aspect of the present invention, a micro-device manufacturing method comprises projecting, through a projection optical system, a pattern of a reticle to a wafer by using an exposure beam in order to transfer the pattern, setting a numerical aperture (N.A.) of the projection optical system by a diaphragm, keeping the temperature of the diaphragm substantially constant during an exposure operation, and manufacturing a micro-device from the wafer.

These and other objects, features and advantages of the present invention will become more apparent from the following description of the preferred embodiments taken in conjunction with the accompanying drawings.

### BRIEF DESCRIPTION OF THE DRAWINGS

FIG. 1 is a view showing the arrangement of an exposure apparatus of a first embodiment of the present invention.

FIG. 2 is a detailed view of a portion of a diaphragm of the first embodiment of the present invention.

FIG. 3 is a view of the arrangement of an exposure apparatus of a second embodiment of the present invention.

FIGS. 4A and 4B are detailed views of a portion of a diaphragm of the second embodiment of the present invention.

FIG. 5 is a detailed view of a portion of a diaphragm and a temperature control unit of a third embodiment of the present invention.

FIG. 6 is a flowchart showing the steps of manufacturing a micro-device.

FIG. 7 is a detailed flowchart showing a wafer process shown in FIG. 6.

### DESCRIPTION OF THE PREFERRED EMBODIMENTS

While embodiments of the present invention will be described below with reference to the drawings, the embodiments by no means limit the present invention.

[First Embodiment]

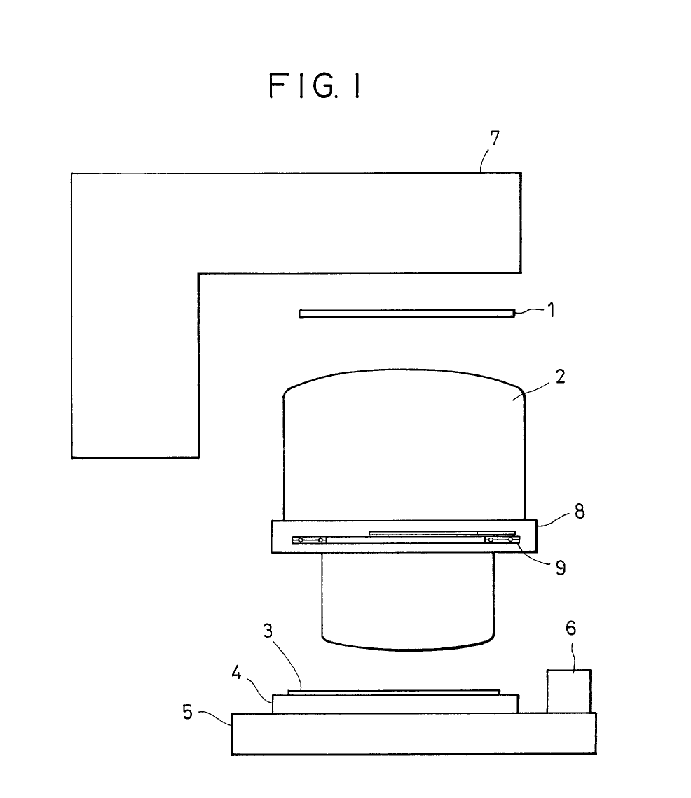

FIG. 1 is a view showing an exposure apparatus of a first embodiment of the present invention. The exposure apparatus of the present invention can be applied to all optical projecting and exposure apparatuses having a projection optical system of a type, which is known as a stepper, a scanner, and the like, and further, the exposure apparatus is also applicable to all types of projection optical systems, such as a refraction type, a catadioptric system and the like. Exemplified here as a typical example is a refraction type exposure apparatus. Further, the exposure apparatus of the present invention can be applied regardless of the wavelength of a light source that is used.

In FIG. 1, reference numeral 1 denotes a reticle on which a pattern to be transferred is formed, numeral 2 denotes a projection optical system, numeral 3 denotes a wafer, numeral 4 denotes a wafer chuck, numeral 5 denotes a wafer stage, numeral 6 denotes an interferometer mirror, and numeral 7 denotes an illumination system. Numeral 8 denotes a numerical aperture switching unit of the projection optical system 2. In FIG. 1, the numerical aperture switching unit 8 is composed of an iris diaphragm 9 and the numerical aperture is changed by changing the diameter of the diaphragm.

In the numerical aperture switching unit 8, a numerical aperture diaphragm has an opening that is opened in a shape corresponding to the effective diameter of the projection optical system. A numerical aperture value, in which the projection optical system 2 is operated, is determined by a pattern to be exposed, and a command is issued to the numerical aperture switching unit 8 from a controller (not shown) of the exposure apparatus. The numerical aperture switching unit 8 is composed of metal and acts as a body for absorbing an exposure beam. When no pattern is formed on the reticle 1, no light beam is irradiated to the portion of the diaphragm provided with the pupil unit of the projection optical system 2. However, when a pattern is formed on the reticle 1, a light beam is scattered thereon and a portion of the scattered light beam directly impinges on the above-noted portion of the diaphragm. For example, when the pattern is a repeated pattern having a duty of 1:1, the ratio of an intensity of a primary light beam and a second light beam is 1:0.41. Therefore, it can be determined found that when a primary light beam of an oblique incident light beam impinges on the numerical aperture diaphragm, a light beam having a considerable amount of intensity impinges on the diaphragm.

In contrast, when the projection optical system is used with a small K₁ (coefficient in the formula (1)) value to obtain a high resolution, a high degree of stability is required for the optical system. In particular, a strict requirement is made regarding the temperature, that is, the temperature is required to have a stability at a level on the order of 0.1°.

The stability is most damaged by an exposure beam. For example, the temperature of a glass material increases corresponding to the amount of the exposure beam absorbed thereby and this generates so-called thermal aberration. In an example of an i-ray projection optical system, a flint glass material, which has a slightly low permeability, must be used to correct chromatic aberration. According to the catalog value of i-ray glass materials, which is available at present, a glass material having a permeability of about 99%/10 mm is included as an i-ray glass material. Actually, however, unless an i-ray glass material having a permeability higher than that is selected, a problem arises in the thermal aberration. However, even if a glass material having a higher permeability is selected, it is a fact that even such a glass material absorbs the exposure beam, although the amount of the absorbed exposure beam is different. Countermeasures against the thermal aberration are providing a correction mechanism, setting a limit value to the energy incident on the projection optical system, and the like. Even an increase in the temperature of only 0.5° C., which is caused by the absorption of the exposure beam, causes a problem.

While a glass material of a type having a high permeability can be optionally selected, a new problem is caused by the influence of the heat absorbed by the diaphragm, depending upon the selection of the numerical aperture value. Since the diaphragm is ordinarily composed of a metallic material, when the exposure beam impinges thereon, the exposure beam is absorbed and reflected by the diaphragm. In particular, when the exposure beam has a short wavelength, a considerable portion thereof is absorbed by the diaphragm. Thus, a large problem is caused by an increase in the temperature due to the absorption of the exposure beam.

The increase in the temperature of the diaphragm is larger than that of the glass material, because the diaphragm absorbs a larger amount of the exposure beam in comparison with the glass material. Accordingly, an increase in the temperature of peripheral air due to the heat resulting from the absorption of the exposure beam and the influence caused by the radiation of the heat cannot be ignored. When the temperature of the peripheral air is increased, a light beam is caused to waver by the Schlieren effect as a transient phenomenon and an imaged state is made unstable. Further, the temperature of glass materials located in the vicinity of the diaphragm is increased by a radiation effect.

The present invention is characterized in that an increase in the temperature of the diaphragm is prevented, even if a light beam impinges thereon, by providing a temperature controller with the diaphragm.

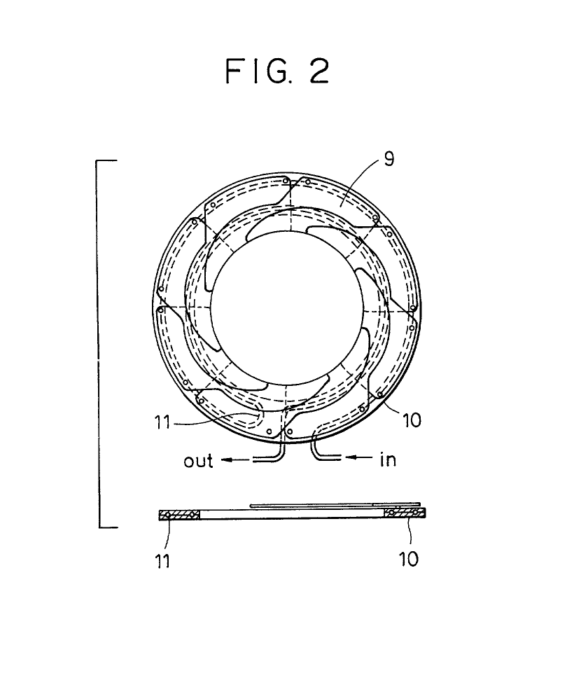

FIG. 2 is a plan view and a sectional view of the iris diaphragm acting as the numerical aperture switching unit 8. In FIG. 2, reference numeral 9 denotes the iris diaphragm arranged such that the numerical aperture is adjusted by a plurality of blades. A temperature adjusting medium such as water flows through a liquid passage 11, which is disposed in the interior of the circular frame 10 of the iris diaphragm 9. The object of the present invention can be achieved by separating a diaphragm diameter variable mechanism from a temperature control device and disposing them so that they are in contact with each other. Further, in FIG. 2, since the liquid passage into which the temperature adjusting medium flows is disposed in confrontation with the liquid passage from which the temperature adjusting water flows out the temperature is made uniform, and distortion of the iris diaphragm 9 is prevented.

In this example, the temperature of the diaphragm 9 is controlled by disposing the piping, through which the fluid flows, in the interior of the circular frame 10. The fluid flow is controlled to have the same temperature as the temperature at which the optical system is desired to be kept. For example, when the temperature of the environment in which the projection optical system is used is 23.0°, the temperature of the fluid flow is also set to 23.0°.

Although in the example of this embodiment, the present invention is applied to an exposure optical system used in the atmosphere, the present invention is also applicable to an exposure apparatus using EUV or X-rays. In that case, the present invention is more effective, because exposure is performed in a vacuum, and a natural radiation effect is reduced more, as compared with a case in which exposure is performed in the atmosphere.

[Second Embodiment]

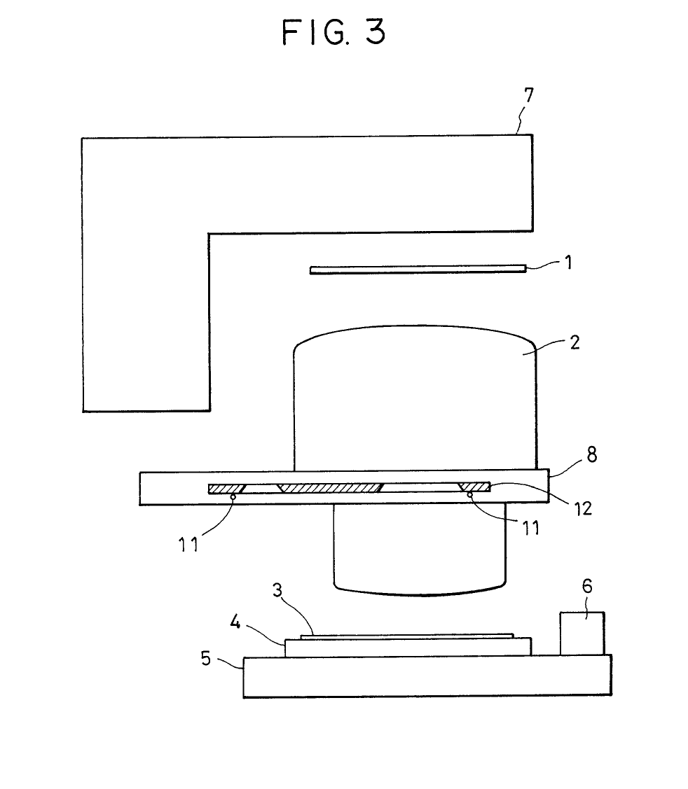

In the above first embodiment, the diameter of the numerical aperture is switched with the iris diaphragm 9. However, the present invention is also applicable to a system in which the diameter of the numerical aperture is changed by a turret, as shown in FIG. 3.

FIG. 3 is a view showing an exposure apparatus of a second embodiment of the present invention and shows a refraction type exposure apparatus as a representative example, similar to FIG. 1. In FIG. 3, reference numeral 1 denotes a reticle 1 on which a pattern to be transferred is formed, numeral 2 denotes a projection optical system, numeral 3 denotes a wafer, numeral 4 denotes a wafer chuck, numeral 5 denotes a wafer stage, numeral 6 denotes an interferometer mirror, and numeral 7 denotes an illumination system. Numeral 8 denotes the numerical aperture switching unit of the projection optical system. The numerical aperture switching unit 8 is composed of a turret 12 and the numerical aperture is changed by setting the diameter of a diaphragm to a desired value by rotation of the turret 12. Thus, the turret can provide a plurality of openings of various sizes.

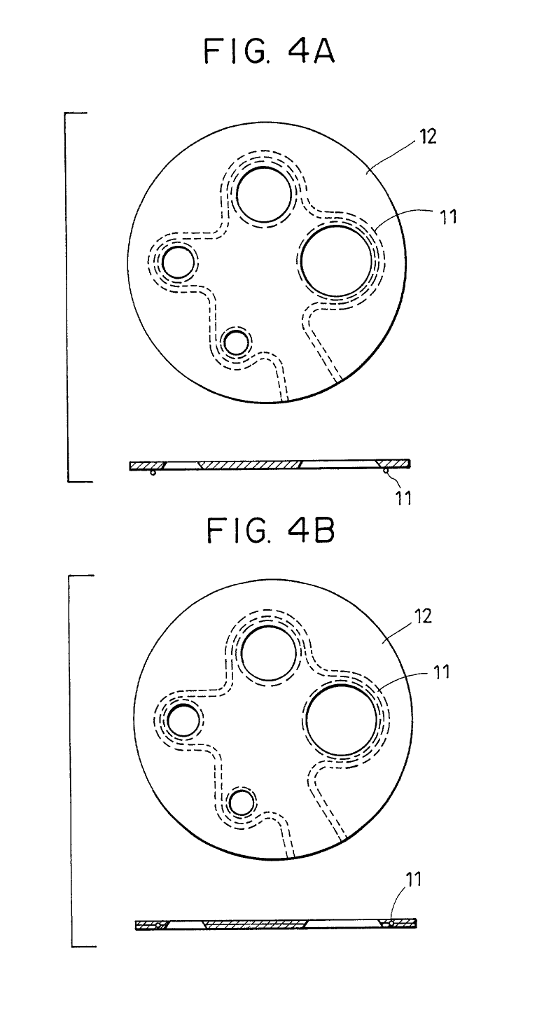

FIGS. 4A and 4B show details of the turret 12 as the numerical aperture switching unit 8 used in the embodiment shown in FIG. 3. In the example shown in FIG. 4A, a piping 11, through which a temperature adjusting medium such as water flows, is directly bonded to the diaphragm. In the example shown in FIG. 4B, a fluid flow passage 11 is formed in the inner construction of the diaphragm and temperature-controlled fluid flows through the passage. The latter case is characterized in that, since the thickness of the diaphragm is increased, the edge portion of an opening has a tapered cross section, so as to eliminate an influence caused by the thickness of the inner construction. In this case, the sharp side of the tapered portion confronts a reticle side.

In the first and second embodiments, the diaphragm may include an independent circulating system for the temperature-controlled fluid. Otherwise, a temperature adjusting medium, which is used in a liquid cooling type temperature control system wound around the periphery of a projection optical system for the thermal stabilization thereof, also may be used in the diaphragm.

[Third Embodiment]

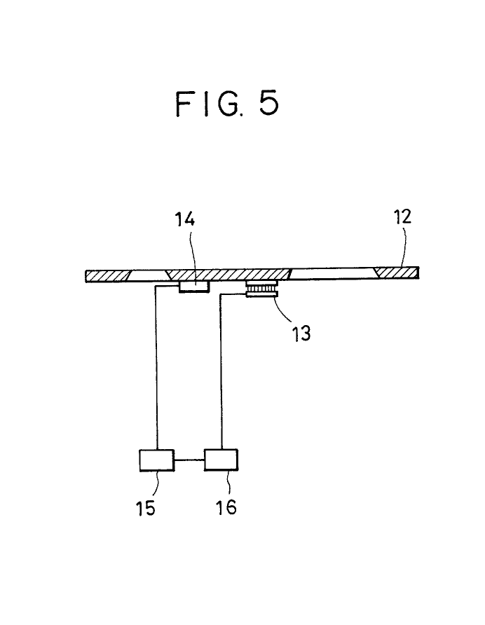

In third embodiment of the present invention, shown in FIG. 5, a Peltier element 13 is used as the cooling means for a diaphragm 12. The Peltier element 13 is bonded to the diaphragm 12 at the wafer side thereof and a thermocouple 14, which is the temperature measuring means of the diaphragm 12, is also bonded to the diaphragm 12 at the wafer side thereof, similarly. An electromotive force of the thermocouple 14 is supplied to a measuring instrument 15 and the Peltier element 13 is operated through a controller 16.

Since the temperature increase of the diaphragm 12 is determined based on the amount of the light beam scattered from a reticle, it is difficult to previously determine how much the diaphragm is to be cooled. The liquid cooling systems shown in FIGS. 1 and 3 employ such a technical concept that a fluid having a predetermined amount of temperature mass flows regardless of an increase in the temperature, so as to keep a constant temperature. However, the example shown in FIG. 5 is such that the temperature is controlled by determining the quantity of cooling to be achieved with the Peltier element 13 according to the value of a measured temperature. When an exposure beam directly irradiates the temperature measuring means itself, the temperature of the temperature measuring means is measured in place of the temperature of the diaphragm 12. Therefore, the temperature measuring means is disposed relative to the diaphragm on the wafer side thereof, to prevent the exposure beam from directly irradiating the temperature measuring means.

Note that, in the examples of FIGS. 1 and 3, a temperature sensor may be separately disposed to obtain the temperature information of the diaphragm, so that the cooling capability of the cooling liquid can be adjusted based on the output from the temperature sensor.

[Fourth Embodiment]

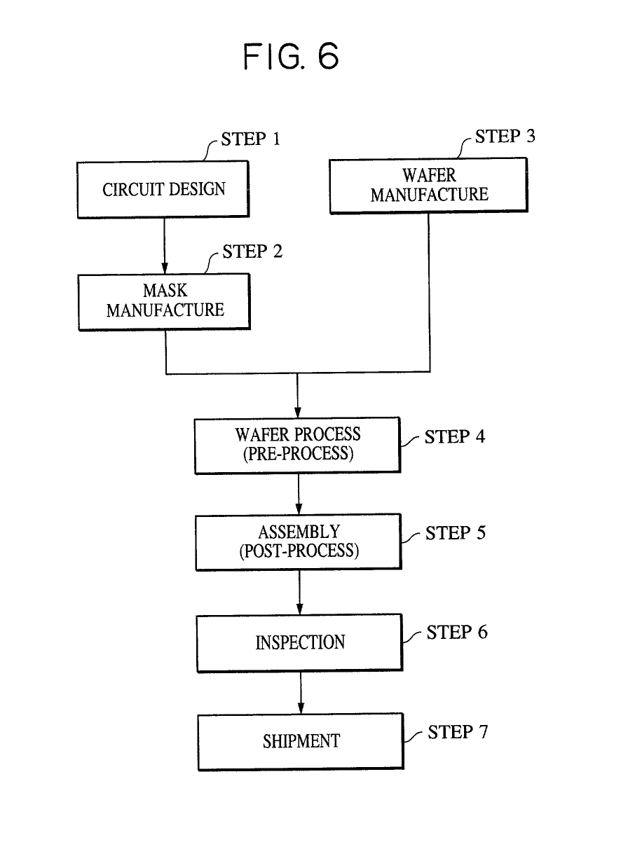

FIG. 6 is a flowchart showing a process for manufacturing a micro-device (e.g., a semiconductor chip such as an IC or an LSI, a liquid crystal panel, a CCD (charge-coupled device), a thin film magnetic head, a micro-machine or the like). At step 1 (circuit design), the circuit design of the semiconductor device is effected. At step 2 (the manufacturing of a mask), a mask, as the substrate described in the above embodiments, formed with the designed circuit pattern, is manufactured. On the other hand, at step 3 (the manufacturing of a wafer), a wafer is manufactured by the use of a material such as silicon. Step 4 (wafer process) is called a pre-process, in which by the use of the manufactured mask and wafer, an actual circuit is formed on the wafer by lithography techniques. The next step, step 5 (assembling), is called a post-process, which is a process for making the wafer manufactured at step 4 into a semiconductor chip, and includes steps such as an assembling step (dicing and bonding) and a packaging step (enclosing the chip). At step 6 (inspection), inspections such as an operation confirming test and a durability test of the semiconductor device manufactured at step 5 are carried out. Via such steps, the semiconductor device is completed, and it is delivered (step 7).

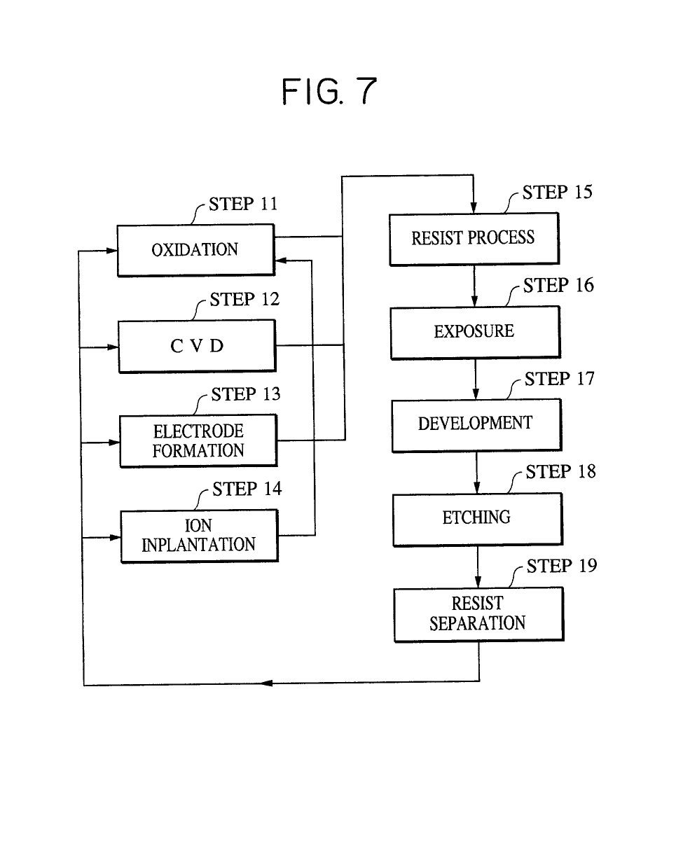

FIG. 7 is a flowchart showing the detailed steps of the wafer process discussed above with respect to step 4 in FIG. 6. At step 11 (oxidation), the surface of the wafer is oxidized. At step 12 (chemical vapor deposition—CVD), an insulating film is formed on the surface of the wafer. At step 13 (the forming of an electrode), an electrode is formed on the wafer by vapor deposition. At step 14 (ion implantation), ions are implanted into the wafer. At step 15 (resist processing), a photo-resist is applied to the wafer. At step 16 (exposure), the circuit pattern of the mask is printed and exposed onto the wafer by the exposure apparatus. At step 17 (development), the exposed wafer is developed. At step 18 (etching), the portions other than the developed resist image are removed. At step 19 (the peeling-off of the resist), the resist, which has become unnecessary after the etching, is also removed. By repetitively carrying out these steps, circuit patterns are multiplexly formed on the wafer. If the manufacturing method of the present embodiment is used, it will be possible to manufacture semiconductor devices having a high degree of integration, which have heretofore been difficult to manufacture.

Except as otherwise disclosed herein, the various components shown in outline or in block form in the figures are individually well known and their internal construction and operation are not critical either to the making or using of this invention or to a description of the best mode of the invention.

While the present invention has been described with respect to what is at present considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An exposure apparatus comprising:
a projection optical system which projects a pattern of a first object to a second object by using an exposure beam in order to transfer the pattern from the first object onto the second object;
a diaphragm which sets a numerical aperture of said projection optical system; and
a mechanism which keeps temperature of said diaphragm substantially constant during an exposure operation by said projection optical system.

2. An apparatus according to claim 1, wherein said mechanism comprises a fluid circulation system, which is provided with said diaphragm, in which a temperature controlled fluid circulates.

3. An apparatus according to claim 2, wherein said mechanism controls the temperature of said diaphragm to be almost the same as that of said projection optical system, during the exposure operation.

4. An apparatus according to claim 3, further comprising a constant temperature system for said projection optical system, said constant temperature system providing the temperature controlled fluid to said mechanism.

5. An apparatus according to claim 1, wherein said mechanism comprises a Peltier element.

6. An apparatus according to claim 1, further comprising a sensor which detects temperature information of said diaphragm, wherein the temperature of said mechanism is controlled based on the sensor output.

7. An apparatus according to claim 6, wherein said sensor is located at a position not being irradiated with the exposure beam.

8. An apparatus according to claim 7, wherein said sensor is provided on said diaphragm, on a side facing the second object.

9. An apparatus according to claim 1, wherein said diaphragm comprises an iris diaphragm.

10. An apparatus according to claim 1, wherein said diaphragm comprises a turret having a plurality of openings.

11. An apparatus according to claim 1, further comprising a reticle stage for holding a reticle as the first object, a wafer stage for holding a wafer as the second object, and said projection optical system comprises an illumination optical system.

12. A micro-device manufacturing method comprising:
projecting, through a projection optical system, a pattern of a reticle to a wafer by using an exposure beam, in order to transfer the pattern from the reticle onto the water;
setting a numerical aperture of the projection optical system by a diaphragm;
keeping temperature of the diaphragm substantially constant during an exposure operation by the projection optical system; and
manufacturing a micro-device from the wafer.

13. A method according to claim 12, wherein said keeping step comprises keeping the temperature of the diaphragm by circulating a fluid proximate to the diaphragm.

14. A method according to claim 13, wherein the temperature of the diaphragm is kept to be almost the same as that of the projection optical system, during the exposure operation.

15. A method according to claim 14, further comprising controlling temperature of the projection optical system as well as that of the diaphragm.

16. A method according to claim 12, wherein said keeping step comprises keeping the temperature of the diaphragm using a Peltier element.

17. A method according to claim 12, further comprising detecting temperature information of the diaphragm with a sensor, and controlling the temperature of the diaphragm based an output of the sensor.

18. A method according to claim 17, further comprising providing the sensor at a location not being irradiated with the exposure beam.

19. A method according to claim 18, further comprising providing the sensor on the diaphragm on a side facing the second object.

20. A method according to claim 12, wherein the diaphragm comprises an iris diaphragm.

21. A method according to claim 12, wherein the diaphragm comprises a turret having a plurality of openings.

22. A method according to claim 12, wherein said manufacturing step comprises a resist process and a development process.
